(19) United States
(12) Patent Application Publication
(10) Pub. No.: US 2025/0334919 A1
(43) Pub. Date: Oct. 30, 2025

(54) BRUSH, METHOD FOR MANUFACTURING BRUSH, AND IMAGE FORMING APPARATUS

(71) Applicant: KONICA MINOLTA, INC., Tokyo (JP)

(72) Inventors: Yukio HOSOYA, Tokyo (JP); Kazutoshi KOBAYASHI, Tokyo (JP)

(21) Appl. No.: 19/095,329

(22) Filed: Mar. 31, 2025

(30) Foreign Application Priority Data
Apr. 24, 2024 (JP) 2024-070465

(51) Int. Cl. G03G 21/00; G03G 15/20

(52) U.S. Cl. CPC G03G 21/0035; G03G 15/2025

(57) ABSTRACT

A brush including a brush bristle, wherein the brush bristle includes a fiber having an endothermic peak having a peak top in a region of 30° C. or more and a glass transition temperature or less in a DSC curve measured by a differential scanning calorimeter during heating at a heating rate of 10° C./min, and the glass transition temperature of the fiber is less than 155° C.

### CROSS-REFERENCE TO RELATED APPLICATION

Japanese patent application No. 2024-070465 filed on Apr. 24, 2024, including description, claims, drawings, and abstract the entire disclosure is incorporated herein by reference in its entirety.

### BACKGROUND OF THE INVENTION

### 1. Technical Field

The present invention relates to a brush, a method for manufacturing a brush, and an image forming apparatus.

### 2. Description of the Related Art

A photoreceptor which is an electrophotographic image bearing member (image bearing member) generally repeats a process including charging, exposure, development, transfer, cleaning, and static elimination in an image forming process. The static elimination process may be performed after the cleaning process, or the cleaning process may be performed after the static elimination process. The electrostatic latent image formed by charging and exposure is visualized and developed with a developer containing toner to turn into a toner image. This toner image is transferred to a transfer material (transfer medium) such as paper by transfer means. Not all of the toner is transferred, and some of the visualized toner remains on the photoreceptor. In the image forming process, some of the toner may also remain on an intermediate transfer member and/or a secondary transfer member. As cleaning means for removing such residual toner, means using, for example, a fur brush, a magnetic brush, or a blade is typical. As such cleaning means, a cleaning blade and/or a cleaning brush are/is mainly adopted from the viewpoint of accuracy of cleaning and/or an apparatus configuration.

Japanese Unexamined Patent Application Publication No. 61-106108 discloses removing residual toner on a photoreceptor using a cleaning brush for electrostatic copiers having a pile yarn formed by twisting two or more types of fibers different in triboelectric series.

Japanese Unexamined Patent Application Publication No. 2014-126618 discloses using a cleaning device for cleaning an intermediate transfer belt in an image forming apparatus. The cleaning device disclosed in Japanese Unexamined Patent Application Publication No. 2014-126618 includes an electrostatic cleaning brush member, a brush member voltage application means for applying a voltage to the brush member, a collection member for collecting toner on the brush member into an electrostatic liquid, and a collection member voltage application means for applying a voltage to the collection member.

The cleaning performance and/or the degree of abrasion of the surface layer of an image bearing member vary(s) depending on a variation in the operating environment of an image forming apparatus, in particular, a variation in temperature and humidity. For this reason, in some cases, it is difficult to perform cleaning only with a cleaning blade from the start of use to the durable life of an image forming apparatus employing an image bearing member and a cleaning blade as cleaning means. Therefore, a cleaning brush that rotates while in contact with the image bearing member may be provided as a cleaning auxiliary member.

Japanese Unexamined Patent Application Publication No. 03-243977 discloses using a cleaning device in an image forming apparatus. The cleaning device includes a cleaning blade that is in contact with a rotating image bearing member, an inlet seal that is disposed on the upstream side in the rotation direction of the image bearing member with respect to the cleaning blade, and a cleaning brush that is disposed between the inlet seal and the cleaning blade. In this cleaning device, the inlet seal prevents scattering of toner scraped off by the cleaning blade. In this cleaning device, the inlet seal is disposed on the upstream side in the rotation direction of the image bearing member with respect to the cleaning blade.

### SUMMARY OF THE INVENTION

However, when the brush is left under a high-temperature and high-humidity environment, brush bristles of the brush may have creep deformation at a contact portion between the brush and a member rubbed by the brush bristles.

In view of this, one object of the present invention is to provide a brush having brush bristles that are less likely to have creep deformation that occurs over time under a high-temperature and high-humidity environment. Another object of the present invention is to provide an image forming apparatus including the brush.

The present inventors have conducted intensive studies in order to solve the above-described problem. In the studies, the present inventors have surprisingly found that the above problems can be solved when a peak top of an endothermic peak is present in a specific temperature region in a DSC curve of a fiber contained in brush bristles measured by a differential scanning calorimeter during heating. Then, the present inventors have completed the present invention.

To achieve at least one of the abovementioned objects, according to an aspect of the present invention, a brush reflecting one aspect of the present invention comprises the followings.

One aspect of the present invention can provide
a brush including a brush bristle, wherein
the brush bristle includes a fiber having an endothermic peak having a peak top in a region of 30° C. or more and a glass transition temperature or less in a DSC curve measured by a differential scanning calorimeter during heating at a heating rate of 10° C./min, and
the glass transition temperature of the fiber is less than 155° C.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic cross-sectional view illustrating a schematic configuration of an image forming apparatus according to one embodiment; and

FIG. 2 is a schematic cross-sectional view illustrating an example of a configuration of a main portion of an image forming section 31Y in the image forming apparatus according to the embodiment.

### DETAILED DESCRIPTION

Hereinafter, one or more embodiments of the present invention will be described, with reference to the drawings if necessary. However, the scope of the invention is not limited to the disclosed embodiments. Note that in the description of the drawings, the same elements are denoted by the same reference signs, and redundant descriptions are omitted. In addition, dimensional ratios in the drawings are exaggerated for convenience of description and may be different from actual ratios.

Embodiments of the present invention will be described below. The present invention is not limited only to the following embodiments and can be variously modified within the scope of the claims. The embodiments described in the present specification can be combined as appropriate to form other embodiments.

Note that in the present specification, “X to Y” indicating a range means “not less than X and not more than Y”. Unless otherwise specified, operations and measurements of physical properties and the like are performed under the conditions of room temperature (20 to 25° C.)/relative humidity of 40 to 50% RH.

### <Brush and Method for Manufacturing the Same>

One aspect of the present invention relates to
a brush including a brush bristle, wherein
the brush bristle includes a fiber having an endothermic peak having a peak top in a region of 30° C. or more and a glass transition temperature or less in a DSC curve measured by a differential scanning calorimeter during heating at a heating rate of 10° C./min, and
the glass transition temperature of the fiber is less than 155° C.

According to this aspect, it is possible to provide a brush having brush bristles that are less likely to have creep deformation over time under a high-temperature and high-humidity environment.

In the present specification, a fiber which has a peak top of an endothermic peak in a region of 30° C. or more and a glass transition temperature or less in a DSC curve measured by a differential scanning calorimeter during heating at a heating rate of 10° C./min and which has a glass transition temperature of less than 155° C. is also simply referred to as “fiber (I)”.

In the present specification, an endothermic peak which has a peak top in a region of 30° C. or more and a glass transition temperature (Tg) or less in a DSC curve measured by a differential scanning calorimeter during heating at a heating rate of 10° C./min, the glass transition temperature being less than 155° C., is also simply referred to as “endothermic peak having a peak top in a region of 30° C. or more and Tg or less”.

The present inventors presume the mechanism of addressing the aforementioned problems by the brush according to the present aspect as follows.

When the fiber has an endothermic peak having a peak top in a region of 30° C. or more and Tg or less, an amorphous part of molecules constituting the fiber is particularly present in a state where volume relaxation has advanced, and the fiber has a stable structure. The fiber having such a structure is less likely to have creep deformation that occurs over time under a high-temperature and high-humidity environment, and thus, the creep deformation of the brush bristle is reduced. The above-described mechanism is based on inference, and the technical scope of the present invention is not limited by the above-described mechanism. Similarly, the correctness of other inferred matters in this specification does not affect the technical scope of the present invention.

The brush according to the present aspect will be described below in detail.

### (Structure of Brush)

The brush according to the present aspect includes brush bristles. Each of the brush bristles includes a plurality of fibers. The brush bristle of the brush according to the present aspect includes a fiber having an endothermic peak having a peak top in a region of 30° C. or more and a glass transition temperature or less in a DSC curve measured by a differential scanning calorimeter during heating at a heating rate of 10° C./min, and the glass transition temperature of the fiber is less than 155° C. The brush bristle may further include other fibers in addition to the fiber (fiber (I)) described above. In one embodiment, the brush bristle preferably includes only the fiber (I). The brush bristle may include a fiber bundle obtained by bundling a plurality of fibers. The brush bristle preferably includes a fiber bundle obtained by bundling a plurality of fibers including the fiber (I). It is more preferable that the brush bristle includes only a fiber bundle obtained by bundling a plurality of fibers including the fiber (I). It is still more preferable that the brush bristle includes only a fiber bundle obtained by bundling a plurality of fibers (I).

In one embodiment, the brush preferably further includes a base portion in addition to the brush bristles. The base portion is not particularly limited as long as it functions as a base of the brush, and is preferably, for example, a cylindrical member or a columnar member. Specific examples of the base portion include, but are not particularly limited to, a shaft. As the shaft, a known shaft may be used. The shaft is preferably a metal shaft. The metal shaft is not particularly limited, and examples thereof include an aluminum shaft, a stainless steel shaft, and a zinc alloy shaft. Among them, an aluminum shaft is particularly preferable as the base portion. The outer diameter of the metal shaft is not particularly limited, but is preferably, for example, 4 mm or more and 10 mm or less. The length of the metal shaft is not particularly limited, but is preferably, for example, 300 mm or more and 500 mm or less, or 300 mm or more and 400 mm or less. In one embodiment, the brush may further include a base fabric in addition to the brush bristles, and the brush may further include a base fabric and a base portion in addition to the brush bristles. In the brush, the base fabric may also serve as the base portion. As the base fabric, a known base fabric may be used. Examples of the base fabric include, but are not particularly limited to, a polyester base fabric, a polypropylene base fabric, and a vinylon base fabric. Among them, a polyester base fabric is particularly preferable as the base fabric. In one embodiment, the brush preferably includes a base fabric and a base portion in addition to the brush bristles. In one embodiment, the brush preferably has a base fabric in which a plurality of fibers including the fiber (I) are woven and implanted, and a metal shaft. In this configuration, the plurality of fibers more preferably includes only a plurality of fibers (I). In one embodiment, the brush preferably has a metal shaft and a base fabric in which a plurality of fiber bundles obtained by bundling a plurality of fibers including the fiber (I) are woven and implanted. In this configuration, each of the fiber bundles is more preferably formed by bundling only the plurality of fibers (I).

The bristle height of the brush bristle is not particularly limited, but is preferably 1.0 mm or more and 5.0 mm or less, more preferably 2.0 mm or more and 4.0 mm or less, and still more preferably 2.5 mm or more and 3.5 mm or less. The bristle height of the brush bristle can be determined as follows. In a case where the brush includes a base portion and does not include a base fabric, the bristle height of the brush bristle represents a distance from the surface of the base portion to the outermost surface (outermost surface of the brush) on which the fibers are present in a direction perpendicular to the surface. Here, when the base portion has a columnar shape or a cylindrical shape, the direction perpendicular to the surface (the surface of the base portion) represents a radial direction from the central axis of the base portion. In a case where the brush includes a base portion and a base fabric, the bristle height of the brush bristle represents a distance from the surface of the base fabric to the outermost surface (outermost surface of the brush) on which the fibers are present in a direction perpendicular to the surface. Here, when the base portion has a columnar shape or a cylindrical shape, the direction perpendicular to the surface (the surface of the base fabric) represents a radial direction from the central axis of the base portion.

In a case where the brush bristle includes a fiber bundle obtained by bundling a plurality of fibers, a bundle fineness of the brush bristle is not particularly limited. In the present specification, the bundle fineness represents the thickness of a fiber bundle obtained by bundling a plurality of fibers. The bundle fineness of the brush bristle is preferably 1 dtex or more and 1,000 dtex or less, more preferably 10 dtex or more and 500 dtex or less, and still more preferably 100 dtex or more and 300 dtex or less. Note that tex is a unit representing the thickness of a fiber or a yarn, and is a unit representing the thickness of a fiber or a yarn by the weight [g] of the fiber or the yarn having a length of 1,000 m. One tex indicates that the fiber or yarn has a length of 1,000 m and a weight of 1 g. Since 1 dtex represents 1/10 of 1 tex, 10 dtex=1 tex.

In a case where the brush bristle includes a fiber bundle obtained by bundling a plurality of fibers, a bundle density of the brush bristle is not particularly limited. In the present specification, the bundle density refers to the density of fiber bundles obtained by bundling a plurality of fibers (the number of fiber bundles per unit area). The bundle density of the brush bristle is preferably 10 kF/inch² or more and 300 kF/inch² or less, more preferably 10 kF/inch² or more and 250 kF/inch² or less, and still more preferably 50 kF/inch² or more and 200 kF/inch² or less. The bundle density of the brush bristle is preferably 1 k/cm² or more and 47 k/cm² or less, more preferably 1 k/cm² or more and 39 k/cm² or less, and still more preferably 7 k/cm² or more and 32 k/cm² or less. Here, “k/cm²” represents “×10³/cm²”. As will be described later, when the fiber bundle is provided in a loop shape, one loop is regarded as two fiber bundles.

The shape of the brush bristle is not particularly limited. In one embodiment, the brush may be a straight bristle brush or a loop brush. In the straight bristle brush, fibers (or a bundle of the fibers) constituting brush bristles are provided in the brush in the form of straight bristles. In the straight bristle brush, the fibers are fixed at only one end. In the straight bristle brush, it is preferable that the tips of fibers are present on a brush surface. In the loop brush, fibers (or a bundle of the fibers) constituting the brush bristles are provided in the brush in a loop shape. In the loop brush, the fibers are fixed so as to form a loop shape. In one embodiment, the fiber (I) may be provided in the brush in the form of straight bristles. The fibers (a plurality of fibers) including the fiber (I) may be provided in the brush in the form of straight bristles. The fiber bundle obtained by bundling a plurality of fibers including the fiber (I) may be provided in the brush in the form of straight bristles. The fiber bundle obtained by bundling a plurality of fibers (I) may be provided in the brush in the form of straight bristles. The fiber bundle including the fiber (I) and the fiber bundle not including the fiber (I) may be provided in the brush in the form of straight bristles. In one embodiment, the fiber (I) is preferably provided in the brush in a loop shape. The fibers (a plurality of fibers) including the fiber (I) are more preferably provided in the brush in a loop shape. The fiber bundle obtained by bundling a plurality of fibers including the fiber (I) may be provided in the brush in a loop shape. The fiber bundle obtained by bundling a plurality of fibers (I) may be provided in the brush in a loop shape. The fiber bundle including the fiber (I) and the fiber bundle not including the fiber (I) may be provided in the brush in a loop shape. The reason for this is that forming the fibers in a loop shape further increases the repulsive force of the fibers and further reduces an amount of deformation against pressure. In the brush according to one embodiment, a plurality of fiber bundles obtained by bundling a plurality of fibers including the fiber (I) may be woven and implanted into the base fabric in a loop shape. A plurality of fiber bundles obtained by bundling a plurality of fibers (I) may be woven and implanted into the base fabric in a loop shape. The fiber bundle may be a fiber bundle obtained by bundling, but not twisting, a plurality of fibers, or may be a fiber bundle obtained by twisting a plurality of fibers and bundling the twisted fibers.

The direction of the brush bristles is not particularly limited. The brush bristles may be provided in an upright state or in an inclined state. In the present specification, the upright state may be a completely upright state or a substantially upright state. The upright state refers to a state in which the fibers constituting the brush bristles are provided such that the tips of the fibers (or fiber bundles) or the tips of the loops are directed in a direction substantially perpendicular to the surface of the base portion or the base fabric. Here, when the base portion has a columnar or cylindrical shape, the direction substantially perpendicular to the surface of the base portion or the base fabric refers to a substantially radial direction from the central axis of the base portion. The direction substantially perpendicular to the surface may be a direction perfectly perpendicular to the surface or a direction approximately perpendicular to the surface. The substantially radial direction may be a perfectly radial direction or an approximately radial direction. In the upright state, the fiber or fiber bundle is not limited to be linear. The inclined state refers to a state in which the fibers constituting the brush bristles are provided such that tips of the fibers (or fiber bundles) or tips of the loops are inclined with respect to the direction perpendicular to the surface of the base portion or the base fabric. Here, when the base portion has a columnar or cylindrical shape, the direction perpendicular to the surface of the base portion or the base fabric refers to a radial direction from the central axis of the base portion. In the inclined state, the fibers or fiber bundles may or may not be linear. In the inclined state, the fibers, fiber bundles, or loops may be, for example, in a curved state.

In one embodiment, the brush may be a rotating brush (brush roller) or a bar-like brush (bar brush), but is preferably a rotating brush. In the rotating brush, bristles of the brush and an object are in sliding contact with each other in a state where the brush is rotating. That is, in the rotating brush, bristles of the brush slide on an object while the brush is rotating. The outer diameter of the rotating brush is not particularly limited, but is preferably 5 mm or more and 100 mm or less, more preferably 10 mm or more and 50 mm or less, and still more preferably 12 mm or more and 25 mm or less.

### (Fiber)

The fiber (I) is preferably a resin fiber. In the present specification, the resin fiber refers to a fiber composed of a substance including a polymer, or a fiber composed of a substance including a polymer and a component which is not a polymer and which is compatible with the polymer and/or dispersed in the polymer. The fiber (I) may be a crystalline resin fiber or an amorphous resin fiber. The crystalline resin refers to a resin having crystallinity. The crystalline resin usually further includes an amorphous part in addition to a crystalline part. The amorphous resin refers to a resin having no crystallinity. Whether or not the resin constituting the fiber (I) has crystallinity can be confirmed by an X-ray diffraction method. The fiber (I) preferably includes a crystalline resin fiber, and preferably includes only the crystalline resin fiber.

The fiber (I) is not particularly limited, and examples thereof include polyester resin fibers, polyamide resin fibers (e.g., nylon resin fibers and aramid resin fibers), and acrylic resin fibers. As polyester resins, crystalline polyester resins and amorphous polyester resins are known. As polyamide resins, crystalline polyamide resins and amorphous polyamide resins are known. Nylon resins in polyamide resins are generally known as crystalline resins. Acrylic resins are generally known as amorphous resins. In one embodiment, the fiber (I) preferably includes at least one type of fiber selected from the group consisting of a polyester resin fiber, a polyamide resin fiber, and an acrylic resin fiber. The fiber (I) more preferably includes at least one type of fiber selected from the group consisting of a crystalline polyester resin fiber, a crystalline polyamide resin fiber, and an amorphous acrylic resin fiber. The fiber (I) still more preferably includes at least one type of fiber selected from the group consisting of a crystalline polyester resin fiber, a nylon resin fiber, and an acrylic resin fiber. The fiber (I) even more preferably includes at least one type of fiber selected from the group consisting of a crystalline polyester resin fiber and a nylon resin fiber. The fiber (I) most preferably includes a crystalline polyester resin fiber. In one embodiment, the fiber (I) preferably includes only at least one type of fiber selected from the group consisting of a polyester resin fiber, a polyamide resin fiber, and an acrylic resin fiber. The fiber (I) more preferably includes only at least one type of fiber selected from the group consisting of a crystalline polyester resin fiber, a crystalline polyamide resin fiber, and an acrylic resin fiber. The fiber (I) still more preferably includes only at least one type of fiber selected from the group consisting of a crystalline polyester resin fiber, a nylon resin fiber, and an acrylic resin fiber. The fiber (I) even more preferably includes only at least one type of fiber selected from the group consisting of a crystalline polyester resin fiber and a nylon resin fiber. The fiber (I) most preferably includes only a crystalline polyester resin. In one embodiment, the crystalline resin fiber contained in the fiber (I) preferably includes at least one type of fiber selected from the group consisting of a crystalline polyester resin fiber and a nylon resin fiber. The crystalline resin fiber contained in the fiber (I) more preferably includes a crystalline polyester resin fiber. The crystalline resin fiber contained in the fiber (I) even more preferably includes only a crystalline polyester resin. In one embodiment, the crystalline resin fiber contained in the fiber (I) may include only at least one type of fiber selected from the group consisting of a crystalline polyester resin fiber and a nylon resin (crystalline nylon resin) fiber. The crystalline resin fiber contained in the fiber (I) may include only a nylon resin (crystalline nylon resin) fiber. A polyester resin generally has a high glass transition temperature, and thus, it is presumed that the polyester resin is less likely to have a molecular motion due to heat and has a more stable molecular structure. The crystalline polyester resin has a crystalline part in which molecular motion is unlikely to occur due to heat, and thus, it is presumed to have a particularly stable molecular structure.

The polyester contained in the polyester resin fibers is not particularly limited, and known polyester may be used. Specific examples of the polyester include, but are not particularly limited to: polyalkylene terephthalate such as polyethylene terephthalate (PET), polypropylene terephthalate (PPT), polytrimethylene terephthalate (PTT), or polybutylene terephthalate (PBT); copolymerized polyester obtained by copolymerizing at least one compound selected from the group consisting of ethylene glycol, propylene glycol (also known as 1,2-propanediol), trimethylene glycol (also known as 1,3-propanediol), 1,4-butanediol, polyethylene glycol, polypropylene glycol, and polybutylene glycol, terephthalic acid and/or a derivative of terephthalic acid, and a third component; and biodegradable polyester such as polylactic acid (PLA), polybutylene succinate, or aliphatic polyester (e.g., poly F-caprolactone). The polyester may be used alone or in combination of two or more types thereof. The polyester fiber preferably contains only one type of polyester. When the fiber (I) includes a polyester resin fiber, the content of polyester in the polyester resin fiber is not particularly limited. When the fiber (I) includes a polyester resin fiber, the content of polyester in the polyester resin fiber is preferably 50% by mass or more and less than 100% by mass relative to the total mass of the polyester resin fiber. When the fiber (I) includes a polyester resin fiber, the content of polyester in the polyester resin fiber is more preferably 60% by mass or more and less than 100% by mass relative to the total mass of the polyester resin fiber. When the fiber (I) includes a polyester resin fiber, the content of polyester in the polyester resin fiber is still more preferably 70% by mass or more and 95% by mass or less relative to the total mass of the polyester resin fiber. When the fiber (I) includes a crystalline polyester resin fiber, the content of crystalline polyester in the crystalline polyester resin fiber is not particularly limited. When the fiber (I) includes a crystalline polyester resin fiber, the content of crystalline polyester in the crystalline polyester resin fiber is preferably 50% by mass or more and less than 100% by mass relative to the total mass of the crystalline polyester resin fiber. When the fiber (I) includes a crystalline polyester resin fiber, the content of crystalline polyester in the crystalline polyester resin fiber is more preferably 60% by mass or more and less than 100% by mass relative to the total mass of the crystalline polyester resin fiber. When the fiber (I) includes a crystalline polyester resin fiber, the content of crystalline polyester in the crystalline polyester resin fiber is still more preferably 70% by mass or more and 95% by mass or less relative to the total mass of the crystalline polyester resin fiber. The derivative of terephthalic acid as a raw material of the above-described copolymerized polyester is not particularly limited, and examples thereof include an anhydride of terephthalic acid and dialkyl terephthalate (e.g., dimethyl terephthalate). The third component as a raw material of the above-described copolymerized polyester is not particularly limited, and examples thereof include: dicarboxylic acid such as adipic acid or isophthalic acid (excluding terephthalic acid); diol (excluding ethylene glycol, propylene glycol, trimethylene glycol, and 1,4-butanediol) and/or a polyalkylene glycol (excluding polyethylene glycol, polypropylene glycol, and polybutylene glycol); and oxycarboxylic acid.

The (co)polymer of monomers including a monomer having a (meth) acryloyl group (herein, also simply referred to as “acrylic (co)polymer”) contained in the acrylic resin fiber is not particularly limited, and may be, for example, a known (co)polymer. The (meth) acryloyl group is a generic term including an acryloyl group and a methacryloyl group. In the present specification, the term “(co)polymer” is a generic term including a copolymer and a homopolymer. The acrylic (co)polymer contained in the acrylic fiber is not particularly limited, and may be, for example, a copolymer of polyacrylonitrile or acrylonitrile and a monomer copolymerizable with acrylonitrile. The monomer copolymerizable with acrylonitrile is not particularly limited, and examples thereof include acrylic acid, methyl acrylate, ethyl acrylate, itaconic acid, methacrylic acid, methyl methacrylate, styrene, acrylamide, methacrylamide, vinyl acetate, vinyl chloride, vinylidene chloride, methallylsulfonic acid, methallylsulfonate, styrenesulfonic acid, styrene sulfonate, allylsulfonic acid, and allyl sulfonate. When the fiber (I) includes an acrylic resin fiber, the content of acrylic (co)polymer in the acrylic resin fiber is not particularly limited. When the fiber (I) includes an acrylic resin fiber, the content of acrylic (co)polymer in the acrylic resin fiber is preferably 50% by mass or more and less than 100% by mass relative to the total mass of the acrylic resin fiber. When the fiber (I) includes an acrylic resin fiber, the content of acrylic (co)polymer in the acrylic resin fiber is more preferably 60% by mass or more and less than 100% by mass relative to the total mass of the acrylic resin fiber. When the fiber (I) includes an acrylic resin fiber, the content of acrylic (co)polymer in the acrylic resin fiber is still more preferably 70% by mass or more and 95% by mass or less relative to the total mass of the acrylic resin fiber.

A polyamide contained in the polyamide resin fiber is not particularly limited, and may be, for example, a known polyamide. The polyamide is not particularly limited, and examples thereof include nylon and aramid. The nylon is not particularly limited, and examples thereof include nylon 6, nylon 66, nylon 69, nylon 46, nylon 610, nylon 12, and poly(meta-xylene adipamide). When the fiber (I) includes a polyamide resin fiber, the content of polyamide in the polyamide resin fiber is not particularly limited. When the fiber (I) includes a polyamide resin fiber, the content of polyamide in the polyamide resin fiber is preferably 50% by mass or more and less than 100% by mass relative to the total mass of the polyamide resin fiber. When the fiber (I) includes a polyamide resin fiber, the content of polyamide in the polyamide resin fiber is more preferably 60% by mass or more and less than 100% by mass relative to the total mass of the polyamide resin fiber. When the fiber (I) includes a polyamide resin fiber, the content of polyamide in the polyamide resin fiber is still more preferably 70% by mass or more and 95% by mass or less relative to the total mass of the polyamide resin fiber. When the fiber (I) includes a nylon resin fiber, the content of nylon in the nylon resin fiber is not particularly limited. When the fiber (I) includes a nylon resin fiber, the content of nylon in the nylon resin fiber is preferably 50% by mass or more and less than 100% by mass relative to the total mass of the nylon resin fiber. When the fiber (I) includes a nylon resin fiber, the content of nylon in the nylon resin fiber is more preferably 60% by mass or more and less than 100% by mass relative to the total mass of the nylon resin fiber. When the fiber (I) includes a nylon resin fiber, the content of nylon in the nylon resin fiber is still more preferably 70% by mass or more and 95% by mass or less relative to the total mass of the nylon resin fiber.

When the fiber (I) includes a resin fiber, the weight average molecular weight (Mw) of a polymer (e.g., polyester, polyamide, or an acrylic (co)polymer) included in the resin fiber is not particularly limited, but may be, for example, in the range of 1,500 to 2,000,000. The weight average molecular weight (Mw) of the polymer contained in the resin fiber can be calculated as a value in terms of polystyrene using a calibration curve prepared by, for example, gel permeation chromatography (GPC) using monodisperse polystyrene standard particles as polystyrene for measuring a calibration curve.

The fiber (I) may include an electrically conductive material. Therefore, when the fiber (I) includes a resin fiber, the resin fiber preferably includes an electrically conductive material. When the fiber (I) includes a crystalline resin fiber, the crystalline resin fiber preferably includes an electrically conductive material. When the fiber (I) includes a crystalline polyester resin fiber, the crystalline polyester resin fiber preferably includes an electrically conductive material. The electrical resistance of the fiber (I) can be adjusted by adding an electrically conductive material to the fiber (I). The electrically conductive material is not particularly limited, and examples thereof include carbon black, metal particles, and metal oxide particles. The electrically conductive material may be used alone or in combination of two or more types thereof. The content of the electrically conductive material in the fiber (I) is not particularly limited, but is preferably 5% by mass or more and 30% by mass or less relative to the total mass of the fiber (I). When the fiber (I) includes two or more types of electrically conductive materials, the content of the electrically conductive material means the total amount thereof.

When the fiber (I) includes a resin fiber, the resin fiber may or may not contain components (other components) other than the polymer and the electrically conductive material. For example, when the fiber (I) includes a crystalline resin fiber, the crystalline resin fiber may or may not contain components other than the polymer and the electrically conductive material. For example, when the fiber (I) includes a crystalline polyester resin fiber, the crystalline polyester resin fiber may or may not contain components other than crystalline polyester and the electrically conductive material. Examples of the components other than the polymer and the electrically conductive material include conventionally known additives for fibers.

The surface resistance value of the fiber (I) at a temperature of 23° C. and a relative humidity of 50% RH is not particularly limited. The surface resistance value of the fiber (I) at a temperature of 23° C. and a relative humidity of 50% RH is, for example, preferably 10¹² Ω/cm or less. The surface resistance value at a temperature of 23° C. and a relative humidity of 50% RH can be measured under an environment of a temperature of 23° C. and a relative humidity of 50% RH using, as a measurement object, the fiber (I) that has been left to stand more than one night under an environment of a temperature of 23° C. and a relative humidity of 50% RH. The surface resistance value can be measured using a probe provided with two rod terminals (each having a thickness of φ² mm) (separated from each other with a distance of 20 mm) connected to a commercially available insulation resistance tester (for example, insulation resistance tester SM-8220 manufactured by Hioki E. E. Corporation) under the condition in which the applied voltage is 100 V.

The fiber material for manufacturing the fiber (I) may be a manufactured product or a commercially available product. In the present specification, the fiber material for manufacturing the fiber (I) is also simply referred to as “fiber material”. Examples of commercially available products of the fiber material are not particularly limited, and examples thereof include Belltron (registered trademark) BR-1 manufactured by KB SEIREN, Ltd., Belltron (registered trademark) 931 manufactured by KB SEIREN, Ltd., and LAUNA (registered trademark) SA-7 manufactured by Toray Industries, Inc. The fiber (I) may be manufactured by, for example, a manufacturing method including heat-treating the fiber material at a temperature lower than the glass transition temperature of the fiber material in the final step of one or more steps including heat-treating the fiber material, as described later.

The brush bristle may contain one type of fiber alone, or may contain two or more types of fibers. When the brush bristle contains two or more types of fibers, at least one type of fiber selected from the group consisting of the two or more types of fibers is the fiber (I). The brush bristle may further contain or may not contain a fiber other than the fiber (I). It is preferable that the brush bristle does not contain fibers other than the fiber (I). The brush bristle may contain, as the fiber (I), one type of fiber alone or two or more types of fibers. The brush bristle preferably includes only the fiber (I). The brush bristle more preferably includes only one type of fiber (I).

The peak top temperature of an endothermic peak of the fiber (I) having a peak top in a region of 30° C. or more and Tg or less is not particularly limited as long as it is present in this region. The temperature region of the fiber (I) in which the peak top temperature of the endothermic peak having a peak top in the region of 30° C. or more and Tg or less is present is preferably 30° C. or more and less than 155° C., more preferably 30° C. or more and 100° C. or less, and still more preferably 45° C. or more and 100° C. or less. The temperature region of the fiber (I) in which the peak top temperature of the endothermic peak having a peak top in the region of 30° C. or more and Tg or less is present is more preferably 55° C. or more and less than 100° C., and still more preferably 55° C. or more and 80° C. or less. The temperature region of the fiber (I) in which the peak top temperature of the endothermic peak having a peak top in the region of 30° C. or more and Tg or less is present is still more preferably 65° C. or more and less than 80° C., and most preferably 65° C. or more and 70° C. or less. When the temperature is within the range described above, the creep deformation of the brush bristles that occurs over time under a high-temperature and high-humidity environment is further reduced. When the temperature is within the range described above, an image forming apparatus including the brush according to the present aspect tends to be able to form a higher-quality image even after a lapse of time in a high-temperature and high-humidity environment.

In the present specification, it is determined that a clear endothermic peak has been confirmed when an endothermic amount at a peak (a portion exhibiting a characteristic like an endothermic peak) of an endothermic peak candidate is 4.0 mJ/mg or more in a DSC curve measured by a differential scanning calorimeter. At this time, it is determined that the peak of the endothermic peak candidate is an endothermic peak. The endothermic amount of the fiber (I) at the endothermic peak having a peak top in the region of 30° C. or more and Tg or less is not particularly limited as long as it is 4.0 mJ/mg or more. The endothermic amount of the fiber (I) at the endothermic peak having a peak top in the region of 30° C. or more and Tg or less is preferably 10.0 mJ/mg or more, more preferably 15.0 mJ/mg or more, and still more preferably 16.0 mJ/mg or more. The endothermic amount of the fiber (I) at the endothermic peak having a peak top in the region of 30° C. or more and Tg or less is particularly preferably 20.0 mJ/mg or more. When the endothermic amount is within the range described above, it is presumed that the volume relaxation of the molecules constituting the fiber (I) advances more, and the molecules have a more stable structure. The endothermic amount of the fiber (I) at the endothermic peak having a peak top in the region of 30° C. or more and Tg or less is preferably less than 100.0 mJ/mg, more preferably less than 80.0 mJ/mg, and still more preferably 60.0 mJ/mg or less. The endothermic amount of the fiber (I) at the endothermic peak having a peak top in the region of 30° C. or more and Tg or less is still preferably 40.0 mJ/mg or less, and most preferably 30.0 mJ/mg or less. Preferable examples of the range of the endothermic amount of the fiber (I) at the endothermic peak having a peak top in the region of 30° C. or more and Tg or less include a range of 4.0 mJ/mg or more and less than 100.0 mJ/mg, and a range of 10.0 mJ/mg or more and less than 80.0 mJ/mg. Preferable examples of the range of the endothermic amount of the fiber (I) at the endothermic peak having a peak top in the region of 30° C. or more and Tg or less include a range of 15.0 mJ/mg or more and 60.0 mJ/mg or less, a range of 16.0 mJ/mg or more and 40.0 mJ/mg or less, and a range of 20.0 mJ/mg or more and 30.0 mJ/mg or less. Note that the range of the endothermic amount of the fiber (I) at the endothermic peak having a peak top in the region of 30° C. or more and Tg or less is not limited thereto. When the endothermic amount is within the range described above, the creep deformation of the brush bristles that occurs over time under a high-temperature and high-humidity environment is further reduced. When the endothermic amount is within the range described above, an image forming apparatus including the brush according to the present aspect tends to be able to form a higher-quality image even after a lapse of time in a high-temperature and high-humidity environment. It is obvious that the endothermic amount at the endothermic peak is preferably in the above-mentioned range also in the case where the peak top temperature of the endothermic peak of the fiber (I) having a peak top in the region of 30° C. or more and Tg or less is present in a temperature region narrower than the region of 30° C. or more and Tg or less. Such a temperature region is not particularly limited. Examples of such a temperature region include: a range of 30° C. or more and less than 155° C.; a range of 30° C. or more and 100° C. or less; a range of 45° C. or more and 100° C. or less; a range of 55° C. or more and 100° C. or less; a range of 55° C. or more and 80° C. or less; a range of 65° C. or more and 80° C. or less; and a range of 65° C. or more and 70° C. or less.

The peak top temperature of the endothermic peak and an endothermic amount at the endothermic peak of the fiber (I) can be determined from a DSC curve obtained by a differential scanning calorimeter by heating the fiber (I) from 0° C. to 160° C. at a heating rate of 10° C./min in a temperature modulation mode. Details of the measurement method will be described in Examples. In this evaluation, when the brush bristle includes a plurality of types of fibers, a measurement sample prepared for each type of fiber may be measured, and the characteristics of the endothermic peak may be determined for each type of fiber.

The glass transition temperature (Tg) of the fiber (I) is not particularly limited as long as it is lower than 155° C. The glass transition temperature (Tg) of the fiber (I) is preferably 40° C. or more and less than 155° C., and more preferably 50° C. or more and 100° C. or less. The glass transition temperature (Tg) of the fiber (I) is more preferably 60° C. or more and 100° C. or less, still more preferably 65° C. or more and 80° C. or less, and most preferably 70° C. or more and 80° C. or less. When the glass transition temperature is within the range described above, the creep deformation of the brush bristles that occurs over time under a high-temperature and high-humidity environment is further reduced. When the glass transition temperature is within the range described above, an image forming apparatus including the brush according to the present aspect tends to be able to form a higher-quality image even after a lapse of time in a high-temperature and high-humidity environment.

The glass transition temperature of the fiber (I) can be determined from a DSC curve measured by a differential scanning calorimeter in the following second heating process. First, measurement in a first heating process of heating the fiber (I) from 0° C. to 300° C. at a heating rate of 10° C./min is performed. Next, after the first heating process, measurement in a cooling process of cooling the fiber (I) from 300° C. to 0° C. at a cooling rate of 10° C./min is performed. Then, after the cooling process, measurement in a second heating process of heating the fiber (I) from 0° C. to 300° C. at a heating rate of 10° C./min is performed. Details of the measurement method will be described in Examples. In this evaluation, when the brush bristle includes a plurality of types of fibers, a measurement sample prepared for each type of fiber may be measured, and the characteristics of the endothermic peak may be determined for each type of fiber.

The single fiber fineness of the fiber (I) is not particularly limited. The single fiber fineness of the fiber (I) is preferably 1.0 dtex or more and 10.0 dtex or less, more preferably 2.0 dtex or more and 8.0 dtex or less, and still more preferably 3.0 dtex or more and 6.0 dtex or less. The single fiber fineness of the fiber (I) is particularly preferably 4.0 dtex or more and 5.0 dtex or less. Note that tex is a unit representing the thickness of a fiber or a yarn, and is a unit representing the thickness of a fiber or a yarn by the weight [g] of the fiber or the yarn having a length of 1,000 m. One tex indicates that the fiber or yarn has a length of 1,000 m and a weight of 1 g. Since 1 dtex represents 1/10 of 1 tex, 10 dtex=1 tex.

### (Method for Manufacturing Brush)

The method for manufacturing the brush according to the present aspect is not particularly limited. The brush according to one embodiment can be manufactured, for example, by a manufacturing method including manufacturing conditions under which the brush bristles contain the fibers (I). Therefore, it can also be said that another aspect of the present invention relates to a method for manufacturing the brush according to the above aspect.

It is preferable that the method for manufacturing the brush includes at least one step including heat-treating a fiber material, and the at least one step includes a final step including heat-treating the fiber material at a temperature lower than a glass transition temperature of the fiber material. In the present specification, the final step of the at least one step including heat-treating the fiber material is also simply referred to as “final step including a heat treatment”. As described above, in the present specification, the fiber material for manufacturing the fiber (I) is also simply referred to as “fiber material”. In the final step including a heat treatment, the fiber material can be converted into the fiber (I) through the heat treatment of the fiber material. According to such a method, the fiber (I) can be more easily achieved in the brush to be manufactured. This mechanism is presumed as follows. When the fiber material is heat-treated at a temperature lower than the glass transition temperature, a volume relaxation phenomenon of molecules occurs in the fiber material, so that an amorphous part of the molecules has a more stable structure. As a result, creep deformation of the fibers that occurs over time under a high-temperature and high-humidity environment is less likely to occur, whereby the creep deformation of the fibers decreases. On the other hand, when the fiber material is heat-treated at a temperature higher than the glass transition temperature, the molecular motion of the amorphous part of the molecules in the fiber material is activated, and thus, it is difficult for the amorphous part of the molecules to have a stable structure. As a result, the effect of preventing an occurrence of the creep deformation of the fiber, which occurs over time in a high-temperature and high-humidity environment, cannot be obtained. Note that, when the fiber is heat-treated at a temperature equal to or higher than the glass transition temperature of the fiber after the fiber is heat-treated at a temperature lower than the glass transition temperature, the stable structure of the amorphous part of the molecule is reset. As a result, the effect of preventing an occurrence of the creep deformation of the fiber, which occurs over time in a high-temperature and high-humidity environment, cannot be obtained. The above-described mechanism is based on inference, and the technical scope of the present invention is not limited by the above-described mechanism. The final step including a heat treatment is not particularly limited, but is preferably a final step including a heat treatment in a manufacturing method (method for manufacturing a brush) using a woven fabric including a fiber material.

Conditions for the heat treatment in the final step including a heat treatment are not particularly limited as long as the heat treatment temperature is lower than the glass transition temperature of the fiber material. The range of the glass transition temperature of the fiber material is the same as the range described as the range of the glass transition temperature of the fiber (I) described above. The heat treatment temperature in the final step including a heat treatment is preferably 35° C. or more and less than the glass transition temperature of the fiber material, more preferably 40° C. or more and less than 100° C., even more preferably 55° C. or more and less than 80° C., and still more preferably 60° C. or more and less than 70° C. The heat treatment temperature in the final step including a heat treatment is particularly preferably 65° C. or more and less than 70° C. When the heat treatment temperature is within the range described above, the creep deformation of the brush bristles that occurs over time under a high-temperature and high-humidity environment is further reduced. When the heat treatment temperature is within the range described above, an image forming apparatus including the manufactured brush tends to be able to form a higher-quality image even after a lapse of time in a high-temperature and high-humidity environment. The heat treatment time in the final step including a heat treatment is not particularly limited, but is preferably 1 hour or more and 1000 hours or less, more preferably 3 hours or more and 800 hours or less, and still more preferably 50 hours or more and 500 hours or less. The heat treatment time in the final step including a heat treatment is more preferably 100 hours or more and 400 hours or less, and most preferably 200 hours or more and 300 hours or less. When the heat treatment time is within the range described above, the creep deformation of the brush bristles that occurs over time under a high-temperature and high-humidity environment is further reduced. When the heat treatment time is within the range described above, an image forming apparatus including the manufactured brush tends to be able to form a higher-quality image even after a lapse of time in a high-temperature and high-humidity environment. The relative humidity during the heat treatment in the final step including a heat treatment is not particularly limited, but is preferably 10% RH or more and 90% RH or less, more preferably 30% RH or more and 70% RH or less, and still more preferably 40% RH or more and 60% RH or less. When the humidity is within the range described above, it is considered that the volume relaxation proceeds more efficiently due to the influence of appropriate water, although the details thereof are unknown.

The heat treatment may be any treatment including heating, and the method is not particularly limited. The method of the heat treatment is not particularly limited, and for example, a known method can be used. Examples of an apparatus used for the heat treatment include a thermostatic bath. The heat treatment can be performed by, for example, allowing the brush before the heat treatment in the final step including a heat treatment to stand for a certain period of time in a thermostatic bath.

The brush according to one embodiment may be manufactured by a known manufacturing method except that the manufacturing method includes manufacturing conditions under which the brush bristles contain the fiber (I). In one embodiment, a method for manufacturing a brush includes manufacturing a brush before a final step including a heat treatment using a woven fabric including a fiber material, and performing the final step including a heat treatment. In one embodiment, the method for manufacturing a brush may be, for example, a method including the following (a) to (c). (a) Manufacturing a fiber material and/or manufacturing a woven fabric including a fiber material. (b) Manufacturing a brush before the final step including a heat treatment using the manufactured woven fabric. (c) Performing a final step including a heat treatment.

The raw material of the fiber material is not particularly limited. The raw material of the fiber material preferably includes the polymer described above for the fiber (I). The raw material of the fiber material may further include, if necessary, the electrically conductive material and/or other components described above for the fiber (I). The method for manufacturing a fiber material, the method for manufacturing a woven fabric containing a fiber material, and the method for manufacturing a brush using the manufactured woven fabric are each not particularly limited, and known methods may be used. The range of the single fiber fineness of the fiber material is not particularly limited. Preferable examples of the range of the single fiber fineness of the fiber material include ranges same as those of the single fiber fineness of the fiber (I) described above. As the fiber material, a commercially available product may be used. As described above, examples of commercially available products of the fiber material are not particularly limited, and examples thereof include Belltron (registered trademark) BR-1 manufactured by KB SEIREN, Ltd., Belltron (registered trademark) 931 manufactured by KB SEIREN, Ltd., and LAUNA (registered trademark) SA-7 manufactured by Toray Industries, Inc.

In the method for manufacturing the brush including the fiber material, a bristle height of bristles of the brush, a bundle fineness of the bristles of the brush, and a bundle density of the bristles of the brush are not particularly limited. Preferable examples of the range of the bristle height of the bristles of the brush before the final step including a heat treatment include ranges same as the ranges of the bristle height of the bristles of the brush described above. Preferable examples of the range of the bundle fineness of the bristles of the brush before the final step including a heat treatment include ranges same as the ranges of the bundle fineness of the bristles of the brush described above. Preferable examples of the range of the bundle density of the bristles of the brush before the final step including a heat treatment include ranges same as the ranges of the bundle density of the bristles of the brush described above.

The method for manufacturing a woven fabric including a fiber material may include fixing the fiber material to a base portion. The method for manufacturing a woven fabric including a fiber material may include weaving the fiber material to a base fabric. The method for weaving the fiber material into the base fabric is not particularly limited, and for example, various known techniques such as pile weaving and electrostatic flocking can be used. When the fiber material is woven into the base fabric, a fiber bundle obtained by bundling a plurality of fiber materials may be prepared in advance, and the fiber bundle may be woven into the base fabric. When the fiber material is woven into the base fabric, a fiber bundle obtained by bundling a plurality of fiber materials is preferably woven into the base fabric in a loop shape. The fiber bundle may be a fiber bundle obtained by bundling, but not twisting, a plurality of fiber materials. The fiber bundle may be a fiber bundle obtained by twisting a plurality of fiber materials and bundling the twisted fiber materials. A fiber material or a fiber bundle obtained by bundling a plurality of fiber materials may be woven into a base fabric in a loop shape, and then, the tip of the fiber bundle may be cut. Thus, a woven fabric in which the fiber material is woven into the base fabric in a straight shape can be obtained.

A method for manufacturing a brush using the manufactured woven fabric is not particularly limited, but may include, for example, fixing the woven fabric to a base portion. Preferably, the method for fixing the woven fabric to the base portion includes wrapping the woven fabric around the base portion. The method for fixing the fiber and/or the woven fabric to the base portion is not particularly limited, and examples thereof include a method for fixing the fiber and/or the woven fabric to the base portion with a double-sided tape and/or an adhesive. The method for fixing the fiber and/or the woven fabric to the base portion is preferably a method for fixing the fiber and/or the woven fabric to the base portion with an adhesive. Examples of the base portion include those similar to the examples of the base portion in the description of the structure of the brush. Examples of the base fabric include those similar to the examples of the base fabric in the description of the structure of the brush.

Examples of a method for manufacturing a brush according to a preferred embodiment include a method including: wrapping, around a base portion, a woven fabric in which a fiber material is woven into a base fabric; fixing the woven fabric to the base portion to obtain an article; and performing a final step including a heat treatment on fibers in the obtained article.

The method for manufacturing a brush according to one embodiment may further include, for example, inclining the brush bristles and/or rapidly cooling the fiber material after the heat treatment in the final step including a heat treatment.

### (Use of Brush)

A brush according to one embodiment is preferably used in an image forming apparatus. The brush according to one embodiment is preferably used for rubbing the surface of a component of an image forming apparatus with brush bristles. The image forming apparatus provided with the brush according to one embodiment is preferably an image forming apparatus that forms an image with an electrophotographic method. The brush according to one embodiment is preferably used for rubbing, with brush bristles, the surface of a component of an image forming apparatus that forms an image with an electrophotographic method. The brush according to one embodiment preferably rubs the surface of a component of the image forming apparatus with brush bristles while the brush is rotating. The component (component of the image forming apparatus) to be rubbed by the brush bristles preferably include at least one selected from the group consisting of an image bearing member, an intermediate transfer belt, a secondary transfer roller, and a secondary transfer belt. The component to be rubbed with the brush bristles is preferably at least one selected from the group consisting of an image bearing member, an intermediate transfer belt, a secondary transfer roller, and a secondary transfer belt, and more preferably an image bearing member. The brush according to one embodiment is preferably used for rubbing, with brush bristles, the surface of at least one selected from the group consisting of an image bearing member and a lubricant while the brush is rotating. An image forming apparatus including the brush according to one embodiment is not particularly limited and may be a known image forming apparatus. The image forming apparatus is preferably, for example, an apparatus described in the description of the image forming apparatus below.

The brush according to one embodiment is preferably a cleaning brush or a lubricant application brush. That is, the brush according to one embodiment is preferably used for rubbing the surface of a component of an image forming apparatus with brush bristles to clean the surface. Alternatively, the brush according to one embodiment is preferably used for rubbing the surface of a lubricant included in an image forming apparatus with brush bristles to supply the lubricant to the surface of a component of the image forming apparatus. Alternatively, the brush according to one embodiment is preferably used for rubbing the surface of a lubricant included in an image forming apparatus and the surface of a component of the image forming apparatus with brush bristles to supply the lubricant to the surface of the component of the image forming apparatus. The lubricant is excluded from the component (the component of the image forming apparatus) to which the lubricant is to be supplied. The component to which the lubricant is to be supplied is not particularly limited, and examples thereof include an image bearing member, an intermediate transfer belt, a secondary transfer roller, and a secondary transfer belt. The lubricant is not particularly limited, and examples thereof include lubricants described below. The brush according to one embodiment is more preferably used for rubbing the surface of a component of an image forming apparatus with brush bristles to clean the surface. The brush according to one embodiment is particularly preferably used for rubbing the surface of a component of an image forming apparatus that forms an image with an electrophotographic method with the brush bristles to remove at least some of developer deposited on the surface. The component (component of the image forming apparatus) to be rubbed by the brush bristles preferably include at least one selected from the group consisting of an image bearing member, an intermediate transfer belt, a secondary transfer roller, and a secondary transfer belt. The component to be rubbed with the brush bristles is preferably at least one selected from the group consisting of an image bearing member, an intermediate transfer belt, a secondary transfer roller, and a secondary transfer belt. The component to be rubbed with the brush bristles is more preferably an image bearing member. The brush according to one embodiment is particularly preferably used for rubbing the surface of an image bearing member of an image forming apparatus that forms an image with an electrophotographic method with the brush bristles to clean the surface, and removing at least some of developer deposited on the surface.

The brush according to one embodiment is preferably used in an image forming apparatus including the brush and a cleaning blade. The brush according to one embodiment is preferably used for cleaning an image bearing member in an image forming apparatus that forms an image with an electrophotographic method. The brush according to one embodiment is more preferably used for cleaning an image bearing member together with a cleaning blade. The brush according to one embodiment is preferably used in an image forming apparatus including a cleaning blade that comes into contact with the surface of an image bearing member to remove some of developer deposited on the surface. The brush according to the embodiment is more preferably used in the image forming apparatus for the purpose of, while the brush is rotating, rubbing the surface of the image bearing member with the brush bristles to remove some of developer deposited on the surface.

When the brush according to the present aspect is used for the above-mentioned purposes, an image forming apparatus including the brush tends to be able to form a higher-quality image even after a lapse of time in a high-temperature and high-humidity environment.

### <Image Forming Apparatus and Method for Manufacturing the Same>

It can also be said that another aspect of the present invention relates to an image forming apparatus including the brush according to the above aspect. According to this aspect, it is possible to provide an image forming apparatus including the brush according to the above aspect. The image forming apparatus is preferably an image forming apparatus that forms an image with an electrophotographic method. An image forming apparatus in which the brush according to the above aspect is to be installed is not particularly limited, and a known image forming apparatus may be used. Examples of the image forming apparatus in which the brush according to the above-described aspect is to be installed include the following image forming apparatus (A) (also simply referred to as “apparatus (A)” in the present specification). The apparatus (A) is an image forming apparatus including an image bearing member, an intermediate transfer belt, and at least one component selected from the group consisting of a secondary transfer roller and a secondary transfer belt. The apparatus (A) forms a toner image on the image bearing member with an electrophotographic method. The intermediate transfer belt is in contact with the image bearing member. The toner image is transferred to the intermediate transfer belt. In the apparatus (A), at least one component selected from the group consisting of the secondary transfer roller and the secondary transfer belt is disposed downstream of the intermediate transfer belt, and transfers the toner image onto a recording medium (for example, paper). Examples of the image forming apparatus in which the brush according to the above aspect is installed include “bizhub C650i” (manufactured by Konica Minolta, Inc.).

The image forming apparatus according to one embodiment preferably further includes cleaning means for cleaning the surface of a component of the image forming apparatus, and the cleaning means preferably includes the brush according to the above aspect. In this configuration, it is more preferable that the cleaning means rubs the surface of a component of the image forming apparatus with the brush bristles. In addition, it is still more preferable that the image forming apparatus forms an image with an electrophotographic method, and that the cleaning means rubs the surface of a component of the image forming apparatus with the brush bristles to remove at least some of developer deposited on the surface. The image forming apparatus according to one embodiment preferably includes lubricant supplying means that supplies a lubricant to the surface of a component of the image forming apparatus, and the lubricant supplying means preferably includes the brush according to the above-described aspect. In this configuration, it is more preferable that the lubricant supplying means rubs the surface of a lubricant with the brush bristles. In these embodiments, the brush according to the above-described aspect preferably rubs the surface of a component of the image forming apparatus with the brush bristles while rotating. The component (component of the image forming apparatus) to be rubbed by the brush bristles preferably include at least one selected from the group consisting of an image bearing member, an intermediate transfer belt, a secondary transfer roller, and a secondary transfer belt. The component to be rubbed with the brush bristles is preferably at least one selected from the group consisting of an image bearing member, an intermediate transfer belt, a secondary transfer roller, and a secondary transfer belt. The component to be rubbed with the brush bristles is more preferably an image bearing member. In these embodiments, the brush according to the above-described aspect preferably rubs the surface of at least one selected from the group consisting of an image bearing member and a lubricant with the brush bristles while rotating.

A preferable embodiment includes, for example, the above-described apparatus (A) including cleaning means that cleans the surface of a component of the image forming apparatus. Preferably, in the apparatus described above, the cleaning means includes the brush according to the above-described aspect, and the cleaning means rubs the surface of a component with brush bristles of the brush that is rotating, to thereby remove at least some of developer deposited on the surface. Here, the surface of the component is preferably the surface of at least one component selected from the group consisting of an image bearing member, an intermediate transfer belt, a secondary transfer roller, and a secondary transfer belt.

An image forming apparatus according to one embodiment preferably includes the brush according to the above aspect and cleaning means including a cleaning blade. An image forming apparatus according to one embodiment preferably includes an image bearing member on which a toner image is formed by an electrophotographic method, and cleaning means that cleans the image bearing member. Here, the cleaning means preferably includes the brush according to the above aspect and a cleaning blade. More preferably, the cleaning means includes the following (i) and (ii). (i) Rubbing the surface of the image bearing member with the brush bristles of the rotating brush to remove some of the developer deposited on the surface. (ii) Bringing the cleaning blade into contact with the surface of the image bearing member to remove some of the developer deposited on the surface.

An image forming apparatus according to one embodiment will be described below with reference to the accompanying drawings. Note that the image forming apparatus in which the brush according to the above aspect is used and the image forming apparatus according to the present aspect are not limited to the following embodiments and illustrated examples.

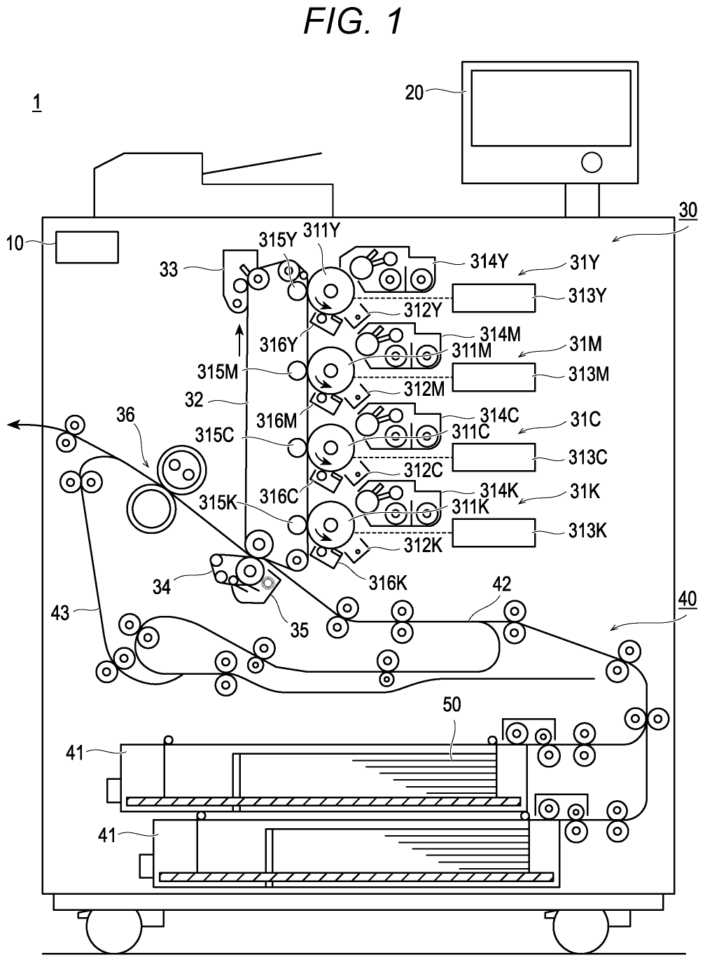

FIG. 1 is a schematic cross-sectional view illustrating a schematic configuration of an image forming apparatus according to one embodiment. As illustrated in FIG. 1, an image forming apparatus 1 includes a controller 10, an operation panel 20, an image former 30, and a sheet feed conveyor 40.

The controller 10 includes a central processing unit (CPU) and a memory, and performs various types of control for the entire image forming apparatus 1 by the CPU executing a control program stored in the memory.

The operation panel 20 includes a touch screen, a numeric keypad, a start button, a stop button, and the like, and is used for input of various settings related to the apparatus, display of the status of the apparatus, and input of various instructions.

The image former 30 includes image forming sections 31Y, 31M, 31C, and 31K, an intermediate transfer belt 32, a cleaning device 33 for the intermediate transfer belt 32, a secondary transferer 34 (a secondary transfer belt in FIG. 1), a cleaning device 35 for the secondary transferer 34, and a fixing device 36.

The image forming sections include components corresponding to respective basic colors of yellow (Y), magenta (M), cyan (C), and black (K). The image forming section 31Y includes a configuration corresponding to yellow (Y). The image forming section 31M includes a configuration corresponding to magenta (M). The image forming section 31C includes a configuration corresponding to cyan (C). The image forming section 31K has a configuration corresponding to black (K). The intermediate transfer belt 32 moves clockwise in FIG. 1 (see the arrow). The image forming sections 31Y, 31M, 31C, and 31K are arranged in such an order that the image forming section 31Y is located most upstream, and the second to fourth image forming sections are the image forming section 31M, the image forming section 31C, and the image forming section 31K, respectively.

The image forming sections 31Y, 31M, 31C, and 31K each include a photoreceptor that is an image bearing member, a charger, an exposure section, a developing section, a cleaner, a lubricant supply section, a primary transferer (e.g., a primary transfer roller), and the like. A yellow developer is accommodated in a developing section 314Y, a magenta developer is accommodated in a developing section 314M, a cyan developer is accommodated in a developing section 314C, and a black developer is accommodated in a developing section 314K. The image forming sections 31Y, 31M, 31C, and 31K are configured similarly except that the colors of toner images formed on photoreceptors 311Y, 311M, 311C, and 311K are different. Therefore, the image forming section 31Y will be described in detail as an example, and description of the image forming section 31M, the image forming section 31C, and the image forming section 31K will be omitted. The developer is not particularly limited, and a known developer may be used. As the developer, two-component developer is preferably used. Two-component developer is composed of carrier and toner. The carriers which are not particularly limited may have, for example, a particle size of 15 μm or more and 100 μm or less and a saturation magnetism of 10 emu/g or more and 80 emu/g or less. The toner which is not particularly limited may have a particle size of, for example, 3 μm or more and 15 μm or less. The toner has negative charging characteristics, and the average charge amount which is not particularly limited may be, for example, −60 μC/g or more and −20 μC/g. As the two-component developer, a mixture of carriers and toner with the toner concentration of 4% by mass or more and 10% by mass or less may be used, for example. Note that the two-component developer is not limited thereto.

The intermediate transfer belt 32, which also functions as a toner bearing member, is rotatably stretched around a plurality of rollers. The intermediate transfer belt 32 which is not particularly limited may be, for example, an 80-μm thick semiconductor belt made of polyimide and having a volume resistivity set to 8 to 11 LOG Ω·cm. The plurality of rollers around which the intermediate transfer belt 32 is stretched includes an opposing roller that forms a transfer nip between the opposing roller and the secondary transferer described below. The opposing roller which is not particularly limited may be made of, for example, nitrile butadiene rubber (NBR). In this case, the rubber hardness is not particularly limited, but may be, for example, 400 (Asker C), and the volume resistivity is not particularly limited, but may be, for example, 8 LOG Ω.

The toner images formed by the respective image forming sections 31Y, 31M, 31C, and 31K are sequentially transferred to the surface of the intermediate transfer belt 32, superimposed, and then transferred onto a sheet 50 conveyed to a transfer position by the primary transferers. The secondary transferer 34 comes into contact with the back side of the sheet at the transfer position and transfers the toner onto the front side of the sheet. The sheet 50 to which the full-color toner image has been transferred is conveyed to the fixing device 36 on the downstream side and is heated and pressurized, whereby a full-color image is formed on the sheet 50.

Transfer residual toner remaining on the intermediate transfer belt 32 without being transferred to the sheet 50 is conveyed to a downstream side, and is collected by the cleaning device 33 for the intermediate transfer belt 32. The cleaning device 33 includes, for example, a brush roller, a lubricant supply section, one or more cleaning blades, and a housing that houses these components. The transfer residual toner on the intermediate transfer belt 32 is cleaned by the cleaning blade. A lubricant is applied to the surface of the intermediate transfer belt 32 by the lubricant supply section. The lubricant supply section in the cleaning device 33 may further include a brush roller. In one embodiment, the brush according to the above-described aspect may be used as the brush roller in the cleaning device 33 and/or the brush roller in the lubricant supply section in the cleaning device 33.

The sheet feed conveyor 40 includes a plurality of sheet feed trays 41 and sheet conveyance paths 42 and 43. A plurality of sheets 50 is stacked on the sheet feed tray 41, and the topmost sheet 50 is fed one by one. The sheet feed conveyor 40 includes a plurality of conveyance roller pairs arranged along the sheet conveyance paths 42 and 43 and a drive motor (not illustrated) that drives the conveyance roller pairs, and conveys the sheet 50 fed from the sheet feed tray 41 to the transfer position of the secondary transferer 34 or the fixing device 36 on the downstream side thereof. The cleaning device 35 for the secondary transferer 34 includes, for example, one or more cleaning blades, a lubricant supply section, a conveyance screw, and a housing case. The cleaning device 35 may further include a brush roller. The lubricant supply section in the cleaning device 35 includes, for example, a brush roller, a lubricant, and a support section. In one embodiment, the brush according to the above-described aspect may be used as the brush roller in the cleaning device 35 and/or the brush roller in the lubricant supply section in the cleaning device 35.

When double-sided printing is performed, the sheet 50 having an image formed on one side is conveyed to the sheet conveyance path 43 for double-sided printing located in a lower part. The sheet 50 conveyed to the sheet conveyance path 43 is turned upside down in a switchback path and then is conveyed to the sheet conveyance path 42 for single-sided printing again, and an image is again formed on the other side of the sheet 50 in the image former 30.

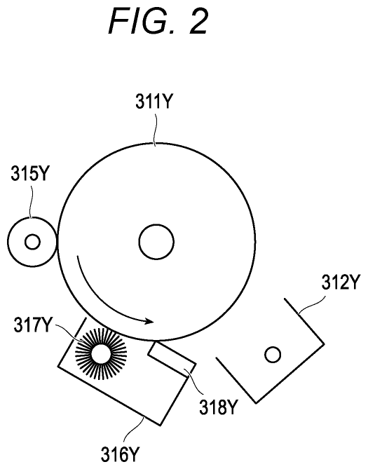

FIG. 2 is a schematic cross-sectional view illustrating an example of a configuration of a main part of the image forming section 31Y. The image forming section 31Y forms a yellow (Y) toner image on the photoreceptor 311Y serving as an image bearing member. For example, the image forming section 31Y includes at least a photoreceptor 311Y, a charger 312Y, an exposure section 313Y (FIG. 1), a developing section 314Y (FIG. 1), a primary transferer 315Y, a cleaner 316Y, and the like. The image forming section 31Y may further include, for example, a lubricant supply section (not illustrated) disposed between the primary transferer 315Y and the cleaner 316Y around the photoreceptor 311Y. The lubricant supply section may include, for example, a rotating brush (brush roller). The lubricant supply section may include, for example, a rotating brush (brush roller), a solid lubricant, and a pressure spring. The brush roller in the lubricant supply section applies the lubricant to the surface of the photoreceptor 311Y. The pressure spring presses the brush roller against the photoreceptor 311Y with the lubricant therebetween. In one embodiment, the brush according to the above aspect may be used as the brush roller in the lubricant supply section.

The specific configuration of the photoreceptor 311Y is not particularly limited. The photoreceptor means an electrophotographic photoreceptor formed by providing an organic compound with at least one of a charge generating function and a charge transporting function which are essential for the formation of the electrophotographic photoreceptor. In the present specification, the photoreceptor includes all known organic photoreceptors such as a photoreceptor composed of a known organic charge generating substance or an organic charge transporting substance and a photoreceptor composed of a polymer complex having a charge generating function and a charge transporting function.

The charger 312Y has a function of applying a uniform potential to the photoreceptor 311Y. The charger 312Y is constituted by, for example, a non-contact charging device. Examples of the non-contact charging device include a corona discharge charger such as a scorotron.

The exposure section 313Y (FIG. 1) performs exposure, based on an image signal (yellow), on the photoreceptor 311Y to which a uniform potential has been applied by the charger 312Y. As a result, an electrostatic latent image corresponding to a yellow image is formed in the exposure section 313Y. The exposure section 313Y may include, for example, light emitting elements and imaging elements arranged in an array in the axial direction of the photoreceptor 311Y. The light emitting element may include, for example, a light emitting diode (LED). The exposure section 313Y may include, for example, a laser optical system.

The developing section 314Y (FIG. 1) includes, for example, a developing sleeve and a voltage application device. A magnet is built in the developing sleeve. A yellow developer is stored in the developing section 314Y. The developing sleeve rotates while holding developer. The voltage application device applies a DC and/or AC bias voltage between the developing sleeve and the photoreceptor 311Y.

The primary transferer 315Y transfers the toner image formed on the photoreceptor 311Y to the intermediate transfer belt 32 (FIG. 1) that is an endless belt. The primary transferer 315Y is disposed in contact with the intermediate transfer belt 32.

The cleaner 316Y includes a rotating brush (brush roller) 317Y, and preferably includes the rotating brush (brush roller) 317Y and a cleaning blade 318Y. The cleaner 316Y may further include, for example, a collection roller, a scraping section, a stopper, and a conveyance screw. These parts of the cleaner are accommodated in a housing. The collection roller is rotationally driven by a motor in a counter direction relative to the rotation direction of the brush roller 317Y. A bias voltage having a polarity opposite to that of the toner is applied from the controller to the shaft body of the collection roller, and the toner on the brush bristles of the brush roller 317Y is attracted by an electrostatic force. The attracted toner adheres to the surface of the collection roller, and the toner removed from the photoreceptor 311Y is collected by the collection roller. The scraping section is in contact with the surface of the collection roller, and scrapes the toner on the surface of the collection roller downward with the rotation of the collection roller. The scraping section includes, for example, a support member and a scraper. The scraper of the scraping section that is in contact with the collection roller in a stopped state scrapes the residual toner on the collection roller. The stopper receives the support member of the rotating scraping section, and thus the rotation of the scraping section is stopped. The conveyance screw has a spiral blade formed around a shaft body, and is rotationally driven by a motor. The conveyance screw is preferably located below the stopper. The residual toner scraped off from the collection roller by the scraper of the scraping section and deposited on the bottom surface of the housing is conveyed in the rotation axis direction by the spiral blade of the rotating conveyance screw, and is discharged to the outside of the housing through a discharge port provided in the housing. The cleaning blade 318Y is a plate-shaped member that comes into contact with the surface of the photoreceptor 311Y to clean the surface of the photoreceptor 311Y. The cleaning blade 318Y has a flat plate shape extending in a rotation axis direction of the photoreceptor 311Y. The cleaning blade 318Y is in contact with the photoreceptor 311Y in the counter direction relative to the rotation direction of the photoreceptor 311Y. The cleaning blade 318Y presses the surface of the photoreceptor 311Y, so that toner (residual toner) or the like remaining on the surface of the photoreceptor 311Y after transfer is scraped off. Some of the residual toner on the photoreceptor 311Y is scraped off by the brush roller 317Y, and the remaining residual toner is scraped off by the cleaning blade 318Y.

The case where the brush according to the above-described aspect is used as the brush roller 317Y has been described above. More specifically, the case where the brush bristles of the brush according to the above-described aspect frictionally slide on the image bearing member while the brush is rotating has been described above. Further, the case where the brush roller 317Y is a cleaning brush has been described in detail above. However, in one embodiment, in an image forming section, a cleaning device for an intermediate transfer belt, and/or a cleaning device for a secondary transferer, for example, the brush according to the above aspect is preferably used as a cleaning brush and/or a lubricant application brush.

### (Lubricant)

The image forming apparatus preferably includes a lubricant. For example, the lubricant used in the image forming apparatus, such as the lubricant used in the lubricant supply section of the image forming section, the lubricant used in the lubricant supply section of the cleaning device 33, and/or the lubricant used in the lubricant supply section of the cleaning device 35, is not particularly limited. As the lubricant, a known lubricant may be appropriately selected and used. The lubricant is preferably solid (solid lubricant). The lubricant is not particularly limited, and examples thereof include a fatty acid metal salt and a fluorine-based resin. The lubricant is preferably a fatty acid metal salt. The lubricant is more preferably a metal salt of a saturated or unsaturated fatty acid having 10 or more carbon atoms. The lubricant is more preferably zinc stearate. The lubricant may be used alone or in combination of two or more types thereof.

### (Image Bearing Member)

The image bearing member used in the image forming apparatus according to one embodiment, such as the photoreceptor 311Y, 311M, 311C, or 311K, is not particularly limited. As the photoreceptor that is an image bearing member, a known photoreceptor may be appropriately selected and used. As the photoreceptor, an organic photoreceptor having a configuration in which a charge generating layer and a charge transporting layer are sequentially laminated on a conductive support, for example, can be used. As the photoreceptor, an organic photoreceptor having a configuration in which a charge generating layer, a charge transporting layer, and a protective layer are sequentially laminated on a conductive support, for example, is preferable. The photoreceptor preferably further includes an intermediate layer having a barrier function and an adhesive function between the conductive support and the charge generating layer. The conductive support, the intermediate layer, the charge generating layer, the charge transporting layer, and the protective layer are not particularly limited, and known ones may be appropriately selected and used for each of them. Examples of the conductive support include: a support formed by shaping a metal into the shape of a drum or a sheet; a support formed by laminating a metal foil on a plastic film; a support formed by depositing a metal or a metal oxide on a plastic film; and a metal, a plastic film or a sheet provided with a conductive layer containing a conductive substance. The intermediate layer may contain, for example, a binder resin, and may further contain, in addition to the binder resin, various conductive particles or metal oxide particles for the purpose of adjusting resistance. The charge generating layer preferably contains, for example, a charge generating substance and a binder resin. The charge transporting layer preferably contains, for example, a charge transporting substance and a binder resin. The protective layer preferably contains at least a resin component obtained by curing a polymerizable compound. The polymerizable compound is not particularly limited, and examples thereof include a monomer which is polymerized (cured) by irradiation with active rays such as ultraviolet rays or electron beams to be converted into a resin generally used as a binder resin for a photoreceptor. The protective layer preferably further contains, in addition to the resin component, metal oxide particles and/or an electron transporting compound that transports charge carriers. The conductive support, the intermediate layer, the charge generating layer, the charge transporting layer, and the protective layer c a component in addition to the aforementioned components.

### (Toner and Developer)

The developer contained in the developing sections used in the image forming apparatus according to one embodiment, such as the developing sections 314Y, 314M, 314C, and 314K, is not particularly limited. As the developer, a known developer may be appropriately selected and used. In the image forming apparatus according to one embodiment, toner (electrostatic latent image developing toner) may be used as a magnetic or non-magnetic mono-component developer, or may be used as a two-component developer by being mixed with a carrier.

The toner is not particularly limited. The toner contains toner base particles. The toner preferably further contains an external additive. As the toner base particles, known toner base particles may be appropriately selected and used. The toner base particles contain at least a binder resin. The toner base particles may further contain other components such as a colorant, a release agent, and/or a charge control agent, as necessary. The binder resin, the colorant, the release agent, the charge control agent, and other components are not particularly limited, and known materials may be appropriately selected and used for each of them. Examples of the binder resin include a thermoplastic resin. Specific examples of the binder resin include: a styrene-based resin; an acrylic resin such as alkyl acrylate and alkyl methacrylate; a styrene-acrylic copolymer resin; a polyester resin; a silicone resin; an olefin-based resin; an amide resin; and an epoxy resin. Examples of the colorant include known inorganic colorants and known organic colorants. Specific examples of the colorant include carbon black. Examples of the release agent include: hydrocarbon wax such as polyethylene wax, oxidized polyethylene wax, polypropylene wax, and oxidized polypropylene wax; carnauba wax; fatty acid ester wax; Sasolwax; rice wax; candelilla wax; jojoba oil wax; and beeswax. Examples of the charge control agent include a metal complex of a salicylic acid derivative with zinc or aluminum (salicylic acid metal complex), a calixarene compound, an organic boron compound, and a fluorine-containing quaternary ammonium salt compound. The external additive is not particularly limited, and examples thereof include fatty acid metal salt particles, inorganic fine particles, and organic fine particles. The fatty acid metal salt particles, the inorganic fine particles, and the organic fine particles are each not particularly limited, and known particles may be used. The fatty acid metal salt particles are not particularly limited, and examples thereof include zinc stearate particles, lithium stearate particles, and magnesium stearate particles. The inorganic fine particles are not particularly limited, and examples thereof include silica particles, titania particles, and alumina particles. The inorganic particles may be surface-treated with, for example, a silane coupling agent, a titanium coupling agent, a higher fatty acid, or silicone oil. The organic fine particles are not particularly limited, and examples thereof include polystyrene particles, polymethyl methacrylate particles, and styrene-methyl methacrylate copolymer particles.

When the electrostatic latent image developing toner is used as a two-component developer, the carrier is not particularly limited, and for example, magnetic particles made of a known material can be used. Such a known material is not particularly limited, and examples thereof include metal such as iron, ferrite, and magnetite, and alloys of these metals and a metal such as aluminum and/or lead. The carrier is not particularly limited, and examples thereof include a resin-coated carrier (coated carrier) in which the surface of magnetic particles is coated with a coating agent such as a resin, and a binder-type carrier in which magnetic fine powder is dispersed in a binder resin. Coating resins that form resin-coated carriers are not particularly limited, and examples thereof include an olefin-based resin, a styrene-based resin, a styrene-acrylic resin, an acrylic resin, a silicone-based resin, an ester resin, and a fluorine resin. The binder resin constituting the binder-type carrier is not particularly limited, and examples thereof include a styrene-acrylic resin, a polyester resin, a fluorine resin, and a phenol resin.

Another aspect of the present invention also relates to a method for manufacturing an image forming apparatus, the method including: manufacturing a brush; and incorporating the brush into the image forming apparatus. It is preferable that the method for manufacturing a brush includes at least one step including heat-treating a fiber material, and the at least one step includes a final step including heat-treating the fiber material at a temperature lower than a glass transition temperature of the fiber material. In the final step including a heat treatment, the fiber material can be converted into the fiber (I) through the heat treatment of the fiber material. Details of each of the brush, the method for manufacturing the brush, and the image forming apparatus in the method for manufacturing an image forming apparatus according to one embodiment are as described above.

While the embodiments of the present invention have been described in detail, it is apparent that this is explanatory and exemplary but not limiting, and the scope of the present invention is to be interpreted by the scope of the appended claims.

The present invention includes the following aspects and modes.

[1]A brush including a brush bristle, wherein
the brush bristle includes a fiber having an endothermic peak having a peak top in a region of 30° C. or more and a glass transition temperature or less in a DSC curve measured by a differential scanning calorimeter during heating at a heating rate of 10° C./min, and
the glass transition temperature of the fiber is less than 155° C.

[2] The brush according to [1], wherein an endothermic amount at the endothermic peak is 10.0 mJ/mg or more.

[3] The brush according to [1] or [2], wherein the fiber includes a crystalline resin fiber.

[4] The brush according to [3], wherein the crystalline resin fiber includes a crystalline polyester resin fiber.

[5] The brush according to any one of [1] to [4], wherein the fiber is provided in the brush in a loop shape.

[6] The brush according to any one of [1] to [5], the brush being used in an image forming apparatus.

[7] The brush according to any one of [1] to [6], the brush being used for rubbing a surface of a component of an image forming apparatus with the brush bristle to clean the surface.

[8] The brush according to any one of [1] to [7], the brush being used for rubbing, with the brush bristle, a surface of a component of an image forming apparatus that forms an image with an electrophotographic method to remove at least some of developer deposited on the surface.

[9]A method for manufacturing the brush according to any one of [1] to [8], the method including
at least one step including heat-treating a fiber material, wherein
the at least one step includes a final step including heat-treating the fiber material at a temperature lower than a glass transition temperature of the fiber material.

[10] An image forming apparatus including the brush according to any one of [1] to [8].

[11] The image forming apparatus according to [10], further including
cleaning means that cleans a surface of a component of the image forming apparatus, wherein
the cleaning means includes the brush, and the cleaning means rubs the surface with the brush bristle.

[12] The image forming apparatus according to [11],
the image forming apparatus forming an image with an electrophotographic method, wherein
the cleaning means rubs the surface with the brush bristle to remove at least some of developer deposited on the surface.

### EXAMPLE

The effect of the present invention will be described by way of the following Examples and Comparative Examples. Note that the technical scope of the present invention is not limited to the following Examples alone. Furthermore, unless otherwise specified, “%” and “part(s)” mean “% by mass” and “part(s) by mass”, respectively.

### <Manufacture of Brush>

### [Manufacture of Brush Before Heat Treatment]

### (Brush 1)

A pile fabric 1 obtained by weaving the following fibers into a polyester base fabric was wrapped around an outer layer of an aluminum shaft having an outer diameter of 5 mm and a length of 330 mm, and fixed with an adhesive. Thus, a brush 1 including the fibers in a loop shape was manufactured.

### <<Pile Fabric 1

Fibers: Crystalline polyester resin fibers (product name: Belltron (registered trademark) BR-1 manufactured by KB SEIREN, Ltd., conductive polyester fibers, a single fiber fineness: 4.4 dtex)
Shape of fibers: Loop shape
Bundle fineness: 210 dtex
Bundle density: 150 kF/inch²
Pile length: 3.0 mm

### (Brush 2)

A brush 2 including loop-shaped fibers was manufactured in the same manner as the brush 1 except that the pile fabric 1 was changed to a pile fabric 2 in which the following fibers were woven into a polyester base fabric.

### <<Pile Fabric 2>>

Fibers: Nylon resin fibers (product name: Belltron (registered trademark) 931 manufactured by KB SEIREN, Ltd., conductive nylon fibers, crystalline resin fibers, a single fiber fineness: 3.3 dtex)
Shape of fibers: Loop shape
Bundle fineness: 210 dtex
Bundle density: 150 kF/inch²
Pile length: 3.0 mm

### (Brush 3)

A brush 3 including loop-shaped fibers was manufactured in the same manner as the brush 1 except that the pile fabric 1 was changed to a pile fabric 3 in which the following fibers were woven into a polyester base fabric.

### <<Pile Fabric 3>>

Fibers: Acrylic resin fibers (product name: LAUNA (registered trademark) SA-7 manufactured by Toray Industries, Inc., conductive acrylic fibers, amorphous resin fibers, a single fiber fineness: 3.3 dtex)
Shape of fibers: Loop shape
Bundle fineness: 210 dtex
Bundle density: 150 kF/inch²
Pile length: 3.0 mm

### (Brush 4)

A brush including loop-shaped fibers was manufactured in the same manner as the brush 1 except that the pile fabric 1 was changed to a pile fabric 4 in which the following fibers were woven into a polyester base fabric. Thereafter, the brush bristles were cut by 0.2 mm at the tip to produce a brush 4 in which the fibers were provided in a straight shape.

### <<Pile Fabric 4>>

Fibers: Crystalline polyester resin fibers (product name: Belltron (registered trademark) BR-1 manufactured by KB SEIREN, Ltd., conductive polyester fibers, a single fiber fineness: 4.4 dtex)
Shape of fibers: Loop shape
Bundle fineness: 210 dtex
Bundle density: 150 kF/inch²
Pile length: 3.2 mm

The outer shapes of the brushes 1 to 4 obtained as described above (the outer shape of the entire brush including the shaft, the base fabric, and the brush bristles) had a size of 13 mm.

### [Heat Treatment in Brush State (Heat Treatment in Final Step in Steps Including Heat-Treating Fiber Material)]

### Example 1

The brush 1 manufactured as described above was set in a jig for fixing the shaft portion of the brush so that the fibers of the brush 1 did not come into contact with any portion, and was heated in a thermostatic bath at a temperature of 65° C. and a relative humidity of 50% RH for 68 hours. Thus, a brush according to Example 1 was manufactured.

### Examples 2 to 9 and Comparative Examples 4 and 5

Brushes according to Examples 2 to 9 and Comparative Examples 4 and 5 were manufactured in the same manner as in Example 1 except that the type of the brushes and the temperature and time of the heat treatment were changed as indicated in Table 1. The relative humidity during the heat treatment for manufacturing each brush was set to 50% RH.

### Comparative Examples 1 to 3

The brushes 1 to 3 that were not subjected to the heat treatment in the brush state were used as brushes according to Comparative Examples 1 to 3, respectively.

In the pile fabrics 1 to 4, the fibers (loops) were provided in an upright state with respect to the base fabric, and the brush bristles of the brushes manufactured as Examples 1 to 9 and Comparative Examples 1 to 5 were in an upright state.

The fibers in the brushes manufactured as Examples 1 to 6, 8, and 9 and the brushes manufactured as Comparative Examples 1 to 5 were provided in a loop shape. The fibers in the brush manufactured as Example 7 were provided in a straight shape.

No obvious change was observed in the bristle heights of the brush bristles of each of the brushes manufactured as Examples 1 to 6, 8, and 9 and the brushes manufactured as Comparative Examples 1 to 5 from the pile length of the fabric used to manufacture the brush. The bristle height of the brush bristles of the brush manufactured as Example 7 was 3.0 mm.

Table 1 indicates characteristics of the brushes and heat treatment conditions for the brushes.

### <Evaluation>

### (Glass Transition Temperature of Fiber)

The glass transition temperature (Tg) of the fiber was checked from a DSC curve measured by a differential scanning calorimeter “DSC7000X” (manufactured by Hitachi High-Tech Science Corporation). More specifically, first, fibers were extracted from the brushes manufactured as Examples and Comparative Examples, and these fibers were used as measurement samples. 1.0 mg of the measurement sample (fiber) was enclosed in an aluminum pan, and the resultant was set in a sample holder of the differential scanning calorimeter “DSC7000X”. For reference, an empty aluminum pan was used. Then, a DSC curve was obtained under measurement conditions in which a first heating process of raising the temperature from 0° C. to 300° C. at a heating rate of 10° C./min, a cooling process of cooling from 300° C. to 0° C. at a cooling rate of 10° C./min, and a second heating process of raising the temperature from 0° C. to 300° C. at a heating rate of 10° C./min were performed in this order.

On the basis of the obtained DSC curve, an extended line of a baseline before rising of a first endothermic peak in the second heating process (that is, a peak appearing on the lowest temperature side in the second heating process) and a tangent line showing a maximum slope between a rising portion of the first endothermic peak and a peak top of the first endothermic peak were drawn, and an intersection point between them was defined as a glass transition temperature (Tg).

Note that, when the glass transition temperature of each of the fibers (fiber materials) before and after the heat treatment was measured, no change in the glass transition temperature due to the heat treatment was confirmed.

Table 1 indicates the glass transition temperature of each fiber.

### (Endothermic Peak of Fiber)

The glass transition temperature (Tg) and the endothermic peak of the fiber were confirmed from a DSC curve measured by a differential scanning calorimeter “DSC7000X” (manufactured by Hitachi High-Tech Science Corporation). More specifically, first, fibers were extracted from the brushes manufactured as Examples and Comparative Examples, and these fibers were used as measurement samples. 1.0 mg of the measurement sample (fiber) was enclosed in an aluminum pan, and the resultant was set in a sample holder of the differential scanning calorimeter “DSC7000X”. For reference, an empty aluminum pan was used. Then, the temperature was increased from 0° C. to 160° C. at a heating rate of 10° C./min in a temperature modulation mode to obtain a DSC curve.

For a peak of the endothermic peak candidate confirmed in the obtained DSC curve, an extended line of the baseline before the rising of the endothermic peak was drawn, and the area of a region obtained by connection of the next contact point between the extended line of the baseline and the DSC curve (the contact point between the extended line of the baseline and the DSC curve which appears next in the direction from the low temperature side to the high temperature side) was defined as an endothermic amount [mJ/mg]. Note that, regarding the extended line of the baseline, for the peak of the endothermic peak candidate, a straight line drawn from the point of 10° C. to the point of 155° C. of the DSC curve was defined as the baseline, and the extended line of the baseline was obtained by extending the baseline. In this measurement, when the endothermic amount at the peak of the endothermic peak candidate was 4.0 mJ/mg or more, it was determined that a clear endothermic peak was confirmed, and it was determined as “having endothermic peak”. On the other hand, when the endothermic amount at the peak of the endothermic peak candidate was less than 4.0 mJ/mg, it was determined that a clear endothermic peak was not confirmed, and it was determined as “not having endothermic peak”. Furthermore, the peak top temperature of the endothermic peak was confirmed.

Table 1 shows the endothermic amount at the endothermic peak and the peak top temperature of each fiber.

### (Amount of Deformation of Brush Due to Creep Deformation)

A drum unit at the K position (drum unit at the position of black color) of a commercially available full color multifunction peripheral “bizhub C650i” (manufactured by Konica Minolta, Inc.) was prepared. The number of drum units at the K position was the same as the number of brushes to be evaluated. Next, the drum unit located at the K position was altered so that a brush could be disposed upstream from a cleaning blade of the cleaning unit. Thus, an altered drum unit was obtained.

Next, the brush according to each of Examples or Comparative Examples was set in the obtained altered drum unit. Note that the biting amount of the brush into the photoreceptor was set to 0.8 mm. Then, the altered drum unit in which the brush was set was placed in a thermostatic bath, heated at a temperature of 50° C. and a relative humidity of 90% RH for 168 hours, and cooled to room temperature.

Thereafter, the photoreceptor was removed from the altered drum unit having the brush installed therein, and an amount of deformation (difference obtained by subtracting the bristle height after the heat treatment from the bristle height before the heat treatment) [mm] of the brush was measured. The obtained value was defined as a creep amount [mm]. In this evaluation, it is preferable that the creep amount is smaller, and when the creep amount was 0.45 mm or less, the brush was determined to be practically preferable. Table 1 shows the creep amounts of the brushes.

### (Pitch Unevenness of Image)

The brush after the measurement of an amount of deformation due to creep deformation was returned to the drum unit at the K position (altered drum unit) which had been altered so that the brush could be mounted on the upstream side relative to the cleaning blade of the cleaning unit. As the altered drum unit, the altered drum unit used for evaluating the amount of deformation due to creep deformation of the brush that was an object for evaluation was used. Then, in place of the drum unit at the K position of the commercially available full-color multifunction peripheral “bizhub C650i”, the altered drum unit having the brush after measurement of the amount of deformation due to creep deformation was set in the full-color multifunction peripheral. Note that the biting amount of the brush into the photoreceptor was set to 0.8 mm. Then, a halftone image formed on the entire surface of one A3 sheet was output in a monochrome mode of the obtained full-color multifunction peripheral. The output image was visually confirmed and evaluated according to the following criteria. In this evaluation, when the pitch unevenness was not confirmed or when the pitch unevenness was slightly confirmed, the brush was determined to be practically preferable. Table 1 shows the results of evaluation of the pitch unevenness of the image.

### <<Evaluation Criteria>>

A: Pitch unevenness is visually unrecognizable
B: Pitch unevenness is slightly visually recognizable
C: Pitch unevenness is clearly visually recognizable

TABLE 1
Characteristics of brush and heat treatment conditions and evaluation results of brush

| | | | | | | | Endothermic peak within | | | | |
|---|---|---|---|---|---|---|---|---|---|---|---|
| | | | | | | | region of 30° C. or more | | | | |
| | | | | | | | and Tg of fiber or less | | | | |
| | Brush before heat | | | Heat treatment | | | | | Peak top | Evaluation result | |
| | treatment | | | conditions | | Tg of | Endothermic | Present | temperature | Creep | |
| | | Fiber | Fiber | Temperature | Time | fiber | amount | or | [° C.] | amount | Pitch |
| | No. | type | shape | [° C.] | [h] | [° C.] | [mJ/mg] | absent | (Note 1) | [mm] | unevenness |
| Example 1 | 1 | Polyester | Loop | 65 | 68 | 72 | 18.0 | Present | 66.2 | 0.04 | A |
| Example 2 | 1 | Polyester | Loop | 65 | 4 | 72 | 7.0 | Present | 64.3 | 0.19 | B |
| Example 3 | 1 | Polyester | Loop | 65 | 200 | 72 | 24.0 | Present | 65.5 | 0.02 | A |
| Example 4 | 1 | Polyester | Loop | 60 | 68 | 72 | 12.0 | Present | 58.8 | 0.10 | A |
| Example 5 | 1 | Polyester | Loop | 70 | 68 | 72 | 5.0 | Present | 70.9 | 0.22 | B |
| Example 6 | 1 | Polyester | Loop | 37 | 68 | 72 | 5.0 | Present | 37.5 | 0.32 | B |
| Example 7 | 4 | Polyester | Straight | 65 | 68 | 72 | 18.0 | Present | 66.4 | 0.12 | A |
| Example 8 | 2 | Nylon | Loop | 45 | 68 | 53 | 6.0 | Present | 44.8 | 0.20 | B |
| Example 9 | 3 | Acryl | Loop | 38 | 68 | 42 | 4.0 | Present | 39.1 | 0.27 | B |
| Comparative | 1 | Polyester | Loop | No heat treatment | | 72 | 0.2 | Absent | | 0.55 | C |
| Example 1 | | | | in brush state | | | | | | | |
| Comparative | 2 | Nylon | Loop | No heat treatment | | 53 | 0.5 | Absent | | 0.72 | C |
| Example 2 | | | | in brush state | | | | | | | |
| Comparative | 3 | Acryl | Loop | No heat treatment | | 42 | 0.3 | Absent | | 0.88 | C |
| Example 3 | | | | in brush state | | | | | | | |
| Comparative | 1 | Polyester | Loop | 80 | 68 | 72 | 15.2 | Absent | (78.6) | 0.48 | C |
| Example 4 | | | | | | | | | | | |
| Comparative | 1 | Polyester | Loop | 100 | 68 | 72 | 18.6 | Absent | (100.3) | 0.62 | C |
| Example 5 | | | | | | | | | | | |

(Note 1)
The values in parentheses in Comparative Examples 4 and 5 are each a peak top temperature of an endothermic peak exceeding glass transition temperature (Tg) of fiber.

From Table 1, it was confirmed that the creep amount of the brush according to each of Examples was smaller than that of the brush according to each of Comparative Examples, and when the brush according to each of Examples was used in an image forming apparatus, the quality of an image formed by the image forming apparatus was satisfactory.

It was also confirmed that the image forming apparatus including the brush according to each of Examples can form an image with higher quality as compared with the image forming apparatus including the brush according to each of Comparative Examples.

While the embodiments of the present invention have been described and illustrated in detail, the disclosed embodiments have been created for purposes of illustration and example only, and not limitation. The scope of the present invention is to be interpreted by the wording of the appended claims.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

1 Image forming apparatus
10 Controller
20 Operation panel
30 Image former
31Y, 31M, 31C, 31K Image forming section
311Y, 311M, 311C, 311K Photoreceptor
312Y, 312M, 312C, 312K Charger
313Y, 313M, 313C, 313K Exposure section
314Y, 314M, 314C, 314K Developing section
315Y, 315M, 315C, 315K Primary transferer
316Y, 316M, 316C, 316K Cleaner
317Y Rotating brush (Brush roller)
318Y Cleaning blade
32 Intermediate transfer belt
33 Cleaning device (for intermediate transfer belt)
34 Secondary transferer
35 Cleaning device (for secondary transferer)
36 Fixing device
40 Sheet feed conveyor
41 Sheet feed tray
42, 43 Sheet conveyance path
50 Sheet

What is claimed is:

1. A brush comprising a brush bristle, wherein
the brush bristle includes a fiber having an endothermic peak having a peak top in a region of 30° C. or more and a glass transition temperature or less in a DSC curve measured by a differential scanning calorimeter during heating at a heating rate of 10° C./min, and
the glass transition temperature of the fiber is less than 155° C.

2. The brush according to claim 1, wherein an endothermic amount at the endothermic peak is 10.0 mJ/mg or more.

3. The brush according to claim 1, wherein the fiber includes a crystalline resin fiber.

4. The brush according to claim 3, wherein the crystalline resin fiber includes a crystalline polyester resin fiber.

5. The brush according to claim 1, wherein the fiber is provided in the brush in a loop shape.

6. The brush according to claim 1, the brush being used in an image forming apparatus.

7. The brush according to claim 1, the brush being used for rubbing a surface of a component of an image forming apparatus with the brush bristle to clean the surface.

8. The brush according to claim 1, the brush being used for rubbing, with the brush bristle, a surface of a component of an image forming apparatus that forms an image with an electrophotographic method to remove at least some of developer deposited on the surface.

9. A method for manufacturing the brush according to claim 1, the method comprising
at least one step including heat-treating a fiber material, wherein
the at least one step includes a final step that includes heat-treating the fiber material at a temperature lower than a glass transition temperature of the fiber material.

10. An image forming apparatus comprising the brush according to claim 1.

11. The image forming apparatus according to claim 10, further comprising
cleaning means that cleans a surface of a component of the image forming apparatus, wherein
the cleaning means includes the brush, and
the cleaning means rubs the surface with the brush bristle.

12. The image forming apparatus according to claim 11,
the image forming apparatus forming an image with an electrophotographic method, wherein
the cleaning means rubs the surface with the brush bristle to remove at least some of developer deposited on the surface.
